(19) United States
(12) Patent Application Publication
(10) Pub. No.: US 2003/0046665 A1
(43) Pub. Date: Mar. 6, 2003

(54) Reusable software component for textually supplementing, modifying, evaluating and processing procedural logic for a compiled host program at run-time

(76) Inventor: Thomas Ilin, Baston (GB)

Correspondence Address: Thomas Ilin, The Old Hall, Baston, Lincolnshire, PE6 9PE, GB

(21) Appl. No.: 09/794,992

(22) Filed: Feb. 28, 2001

(51) Int. Cl. G06F 9/44

(52) U.S. Cl. 717/126

(57) ABSTRACT

A reusable software component that enables procedural rules in the form of text to be edited, viewed, checked for valid rule syntax, and evaluated after assigning values to variables during run-time of a compiled host program in such a way that supplements or modifies the procedural logic of that host program. Thereby enabling a computer's behavior to be modified, or helping it to reach some conclusion or result, based on conditions that need not or cannot be pre-determined before run-time and compiled into the host program. This component can be used in either or both a graphical user interface, GUI, mode and/or a non-GUI mode. This component can be associated with other software components, and it can be customized to apply a specific rule syntax.

### CROSS-REFERENCE TO RELATED APPLICATIONS

Not Applicable

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND. FIELD OF THE INVENTION

This invention relates to computer software components which are embedded in host programs.

### BACKGROUND. DESCRIPTION OF PRIOR ART

Computer programming languages are designed to specify procedural logic for the functional scope of a computer program. This is true even in object oriented languages where an overall linear procedural flow has been replaced by an event-driven procedural flow.

Procedural logic is comprised of one or more procedural rules (If . . . then . . . else, etc statements). Each of which can be an application rule, a technical rule, or some combination of the two. Combined procedural rules are very common in most computer programs, but they create difficulties when changes need to be made.

An example of a pure application rule is: “If Customer Age is greater than 18 then Open Account, else Open Guaranteed Account”.

An example of a pure technical rule is: “If Server is running then Connect To Server”.

An example of a combined business and technical rule is: “If Customer Credit Authorisation is declined then Display ‘Customer credit authorisation declined.’”

In commercial computer software, application rules are called business rules. The remainder of this section will refer to business rules, but the comments made can equally be applied to the broader concept of application rules (including non-business rules such as scientific or operational rules).

It has recently been recognized that a large proportion of requests for commercial application changes arises from the need to change business rules more frequently than technical rules. If these business rules were separated from technical rules, and made more accessible to change in computer programs written in a wide range of languages, then computer software applications could be made to be significantly more responsive to business needs.

Consequently, various solutions to this challenge have been invented.

One approach has been to speed up the software development cycle with new methods and tools, generically referred to as Rapid Application Development (RAD) techniques. Thereby avoiding the need to make a distinction or separation between the two types of rule by responding to changing business rules with a total re-write and re-compilation of computer software. Examples of this is are most integrated CASE tools, and U.S. Pat. No. 5,787,431 (1998) to Shaughnessy.

Another approach has been to use high level pseudo-code tools that focus on building procedures using only business rules, and then generating technical solutions from these procedures incorporating technical rules. This externalizes business rules and separates them from technical rules, but translation and re-compilation of source code to object modules is still necessary. An example of this is U.S. Pat. No. 5,204,939 (1993) to Fujitsu, which constructs rules prior to compilation and links to an inference engine object module after compilation.

There are solutions that approach the problem by offering software with pre-defined configuration parameters, application program interfaces (APIs), and selectable icons to re-configure their inherent procedural logic. Examples of this approach are SAP applications software, and U.S. Pat. No. 5,796,394 (1998) to Sony Corp, which uses keypad entry on personal communicators to define procedural logic for message routing.

Then there are approaches which partially solve the problem by providing a way to specify and modify formulas, a non-procedural kind of business rule (such as an algorithm for calculating interest rates), but they fail to deal with the fundamental issue of changing procedural logic and decision branches (using an If . . . then . . . else style syntax) of host computer programs. Examples of this approach are utility applications such as Microsoft Excel, and formula-engine software components such as biz-Calc.

Although it is apparent that existing approaches solve some aspects this challenge, they all lack one or more of six key features:

1. an ability to externalize procedural logic used by a compiled computer program in a way that enables business rules to be isolated and modified;

2. an ability to supplement, modify, evaluate and process procedural logic for a compiled computer program at run-time without needing to modify source code and re-compile;

3. an ability to work with externalized procedural logic in the form of procedural rule text rather than by other less flexible methods such as changing fixed parameters or selecting from a range of fixed options;

4. enabling the end-users of a computer program to modify procedural logic directly by an easy interface and a choice of simple rule syntaxes;

5. enabling the technical rules in a computer program to remain undisturbed, thereby ensuring its ongoing technical integrity; and

6. an ability to easily incorporate the above-mentioned features in a standard way into programs encoded in a wide range of computer languages and utilities.

With the advent of software components using such standards as COM, COM+ and CORBA, new opportunities have emerged for making business rules, and procedural logic in general, more accessible to change in computer software.

The nature of software components lends them uniquely to solving all six of the above-mentioned missing features. However few attempts have been made to provide a complete solution.

No patents relating to rule management exist in the background area of the present invention. The commercially available software components having closest coverage are biz-Calc and biz-Runner, but they both deal with non-procedural formula calculation rules, and are designed to extend SQL query capabilities. They do not specifically deal with procedural business rules, and their user interface is not designed for real-time interaction during run-time of a host program. They can be found on the componentsource.com commercial website under the ‘Business Rules Components’ category. The FactPool software component in that same category is the first embodiment of this present invention, developed and published by this inventor through Silver Bear Associates Inc.

### BRIEF SUMMARY OF THE INVENTION

The present invention is a re-useable software component which allows a software developer to provide a means for software end-users to supplement, modify and evaluate the procedural logic of a compiled program at run-time. It does this by enabling certain rules to be externalized and subject to change, either by a GUI based presentation of those rules in textual form for editing by the end-user, or by the host program directly feeding rules to the software component in the form of textual strings. Then the software component validates the rules according to a selected syntax and follows the procedural logic until the rules instruct it to pass procedural flow back to the host program. In addition to the ability to follow the conditional branches of a procedural flow, the software component is able to assign values to variables and evaluate formulas incorporating those variables, and to pass the results back to the host program.

Accordingly, besides the general objects and advantages of software components, several objects and advantages of the present invention are:

1. to provide an ability to externalize procedural logic used by a compiled computer program in a way that enables business rules to be isolated and modified;

2. to provide an ability to supplement, modify, evaluate and process procedural logic for a compiled computer program at run-time without needing to modify source code and re-compile;

3. to provide an ability to work with externalized procedural logic in the form of procedural rule text rather than by other less flexible methods such as changing fixed parameters or selecting from a range of fixed options;

4. to enable the end-users of a computer program to modify procedural logic directly by an easy interface and a choice of simple rule syntaxes;

5. to enable the technical rules in a computer program to remain undisturbed, thereby ensuring its ongoing technical integrity; and

6. to provide an ability to easily incorporate the above-mentioned features in a standard way into programs encoded in a wide range of computer languages and utilities.

Further objects and advantages are to accumulate a common pool of acknowledged facts which is shared by the user community, and a common library of rules which are adopted as a the definitive business rules for a business area or enterprise.

Initially these are to be managed and preserved by secondary actions of the host program, such as pasting rule text supplied by the software component to rows in database tables for persistent storage. For example, pasting appropriate segmentation rule text to a column in each row of a segmentation table. Facts could be treated in a similar way.

In future patents this will be expanded to software components which automate services for fact extraction from source databases and rule library management.

Facts in the above-used sense are any data attributes referenced in procedural rules, whether they be basic facts, assumed facts or facts derived in some way.

### BRIEF DESCRIPTION OF SEVERAL VIEWS OF THE DRAWING

The drawings numbered FIG. 1 to FIG. 4 show the GUI interface of a preferred embodiment of this invention. However, this invention is not restricted to one embodiment, being adaptable to many alternative embodiments of the claims made herein. It also has a non-GUI variation which has no visual representation.

The drawings show the GUI of a software component called FactPool-Result, which is a commercially available manifestation of this invention.

FIG. 1 shows the main visible parts of this software component.

FIG. 2 shows that windows in the component can be ‘Docked’ and ‘Locked’, here showing the component being used to display only prompting text in the Result window.

FIG. 3 shows a simple procedural rule being edited, with feedback values and value calculation formulas, and with the Fact/Operator window listing operators for selection.

FIG. 4 shows a simple procedural rule with the Fact/Operator window listing facts and fact values.

Reference numerals in drawings:

| | |
|---|---|
| 1. | Result window |
| 2. | Rule window |
| 3. | Fact/Operator window |
| 4. | Splitter1 Bar |
| 5. | Splitter2 Bar |
| 6. | Prompt text in the Result window |
| 7. | Docked and Locked windows |
| 8. | Procedural rule line with formula |
| 9. | Operator selection window |
| 10. | Procedural outcome rule line |
| 11. | Facts list |
| 12. | Fact values |

The overall dimensions of this software component can be resized during the design phase, when embedding it in a host program. Therefore scaling the diagrams is not applicable. It can also be hidden (made invisible) by setting its Visible property to False.

### DETAILED DESCRIPTION OF THE INVENTION

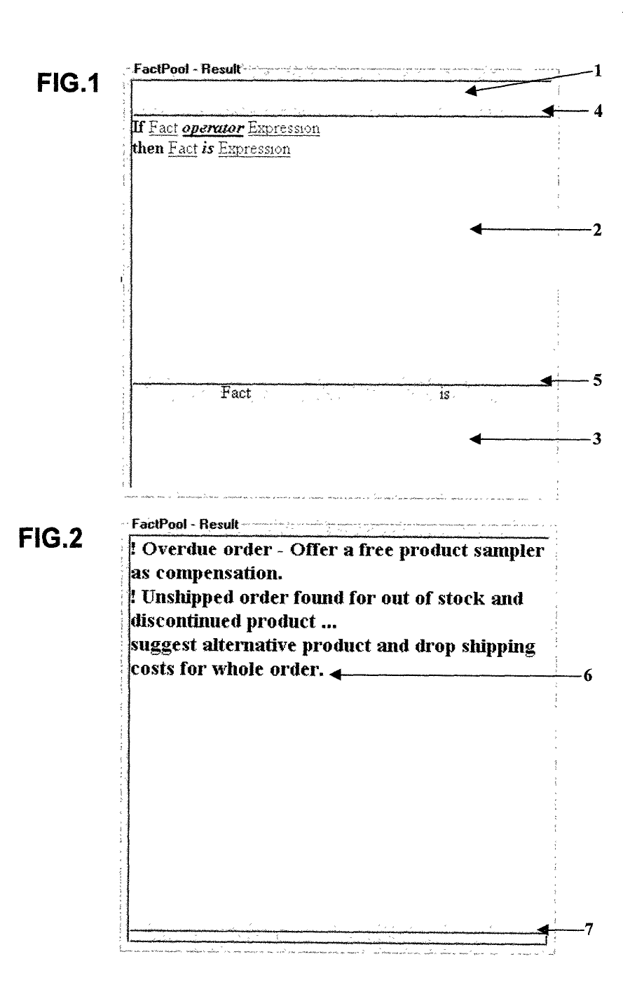

In conjunction with the GUI of the preferred embodiment of this invention defined in the FIG. 1 to FIG. 4 of this patent application, the detailed explanation and software component definition of this section completely discloses the present invention. Thereby enabling someone skilled in the art of developing software components to build an example this invention.

The basis of prior art for this invention is software components intended for embedding in host computer programs. These may be compliant with COM, COM+, CORBA or some other component definition standard. The exact nature of the component structure is not important to this present invention. In the broadest sense, the term software component is intended to mean a distinct piece of software which is designed to be incorporated within host software to provide additional functionality of value to the host software and its end-users.

In particular, as an extreme possibility this invention refers to software components embedded in compiled host software. However, this terminology is not intended to exclude other possibilities of the present invention being embedded in host programs that use a pseudo-code translation process at run-time, such as programs written in the Java language. These are also deemed to be compiled host programs, even though they are not precompiled but translated into machine readable instructions at the last moment at run-time.

The method of constructing this software component is a simple matter of applying prior art to constructing a software component in a language such as Microsoft Visual Basic 6.0 (Professional Edition) using the GUI and Software Component Definition contained in this specification and general programming skills (also, see references 1 and 2 at the end of this section). The main claim of this present invention is a new use of re-useable software components for textually supplementing, modifying, evaluating and processing procedural logic for compiled host programs at run-time. This is not an obvious new use, as software component technology has been around for nearly ten years, and the problems addressed by this present invention have been around for much longer. Even so, the idea of providing end-users with textual control over procedural logic used by compiled computer programs at run-time has not been applied through software components before.

The particular embodiment of the present invention shown in FIG. 1 to FIG. 4 has a simple rectangular shape. This can be re-sized when being placed in a host program's GUI during the latter's design development phase.

FIG. 1 shows that the software component has, in its visible GUI version, three windows 1,2 and 3. These windows are separated by moveable splitter bars 4 and 5.

The Result window 1 is used for two purposes. During Edit mode it can be used to enter rule text, which is subsequently incorporated into the rule after the Enter(or Return) key is pressed. During View mode it can be used to display textual prompt information created by an evaluated rule as shown in 6 of FIG. 2.

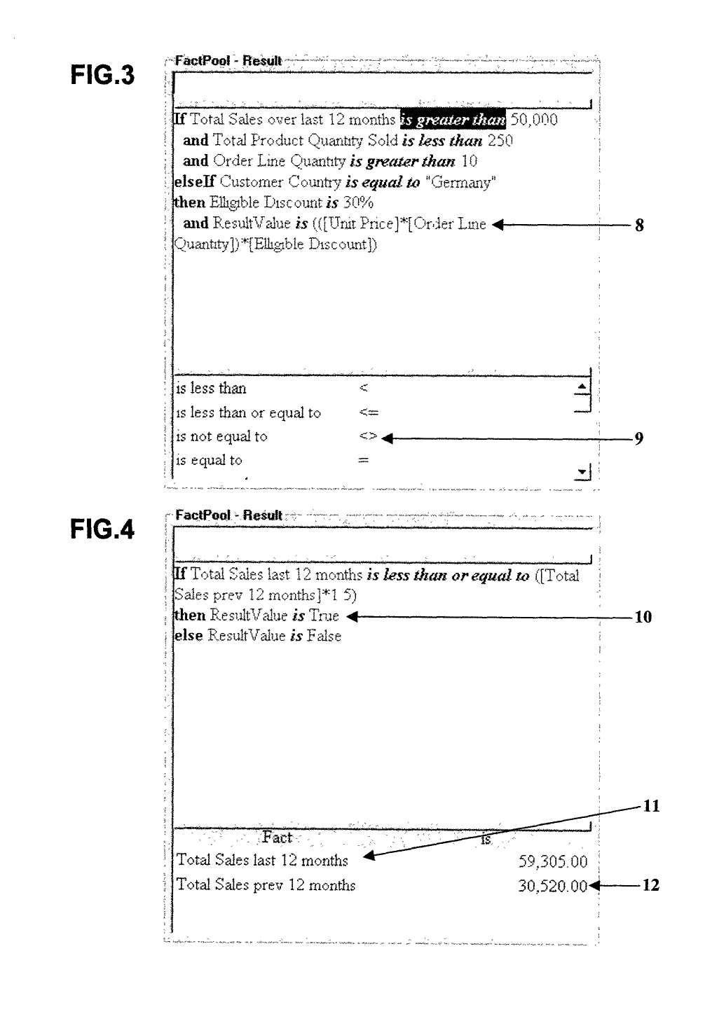

Rule window 2 is used to display rule text. FIG. 1 shows the startup rule text for the basic syntax of a particular syntax type (in this instance the syntax type is standard commercial rule syntax). Text that is underlined is called a ‘syntax placeholder’ for rule parameters. A rule must have all its syntax placeholders replaced by rule parameters before it can be validated (see 8 of FIG. 3 and 10 of FIG. 4 for examples of completed rules with all placeholders replaced).

This embodiment of the present invention uses Rich Text Format (RTF) to represent rule text and to give it special formatting such as colour, underline and italic fonts. Other techniques could be used for distinguishing rule parts such as special control characters.

Given the basic syntax shown in FIG. 1 this embodiment allows the end-user to click on different syntax placeholders in the Rule window to highlight them for editing. Then if Facts or Expressions are being edited, whatever is entered into the Result window 1 will replace the highlighted syntax placeholder and be added to the Facts list 11 when the Enter (or Return) key is pressed. Otherwise if the end-user clicks on an Operator, they can select from a list 9 of possible operators that appears in the bottom Fact/Operator window 3.

When the Esc key is pressed while in Edit mode the software component calls its own Validate method. This can also be called directly by the host program. If the rule text is valid the ValidRule property is set to True, and the Evaluate method can be called.

After the host program has supplied the software component with values 12 for each Fact by loading the Facts array property, the Evaluate method evaluates the first part of a rule (the clauses before the ‘then’ clause) from which a boolean condition arises which triggers processing either the ‘then’ clause lines or, if present, an ‘else’ clause set of lines. Consequently the Result property may be assigned a text string for display in the Result window, or the ResultValue property may be given values, or it may be assigned a boolean condition. These are used by the host program, for example in ‘Select Case . . . ’ statements, to make conditional branches back into the host program event-driven procedural flow.

A single procedural rule can be processed in this way, or a sequence of multiple procedural rules can be processed with ResultValues being passed between them by assigning the software component's Cumulative property a True value.

From the description above, it becomes evident that a software component is ideally suited to externalizing procedural logic either through a GUI to the end user, or through the component's properties directly to a host program. By the nature of a software component this capability can be readily made available at run-time of the host program, after compilation. Thereby all of the objectives and advantages mentioned in the summary section of this patent application are achieved.

### References:

Dan Appleman, “Developing COM/ActiveX Components with Visual Basic 6”, SAMS, pp 202-228, 1999.

Jason Pritchard, “COM and CORBA Side by Side”, pp. 17-30, Addison Wesley Longman, 1999.

Software Component Definition:

An Events, Methods and Properties Definition of a Software Component for Textually Supplementing, Modifying, Evaluating and Processing Procedural Logic for a Compiled Host Program at Run-Time.

In conjunction with the GUI defined in the FIG. 1 to FIG. 4 of this patent application, and the preceding part of this section, the following object specification completely discloses the present invention. Thereby enabling someone skilled in the art of developing software components to build an example this invention.

Events

Error Event

Occurs when a trappable error condition is reached.

Private Sub object_Error([ErrorText As String], [ErrorSource As String])

The event syntax has these parts:

| Part | Description |
|---|---|
| object | An object expression that evaluates to a FactPool control. |
| ErrorText | A string that describes an error condition. |
| ErrorSource | A string that contains the cause of the error condition. |

Remarks:

In fpEdit mode errors are displayed in a message box for interactive response by the user, and the Error event is not raised. During fpValidate and fpEvaluate modes the Error event provides ErrorText and ErrorSource strings so that appropriate messages and actions can be taken by the host program. An interactive error message box is not shown by the control in those modes because the control may be running through a ‘batch’ of Rules, as in the ‘Dynamic Segmentation’ example of the ResultDemo program.

An example of an ErrorText string concatenated with an ErrorSource is:

#210: Load Rule error . . . File not found: c:\factpool\segrule.rtf

Evaluated Event

Occurs when the Evaluate method has completed successfully.

Private Sub object_Evaluated( )

The event syntax has these parts:

| Part | Description |
|---|---|
| object | An object expression that evaluates to a FactPool- |
| | Result control. |

Remarks:

If the Evaluate method returns True then this event notifies the host program that the Rule's then clause assignment statements have been performed. Therefore, the Result and ResultValue properties will have new values if assigments are made to them in the then clause. Value assignments can also be made to other Facts in then clauses, and these can be accessed through the Facts property as normal.

Evaluated Event

Occurs at processing milestones, such as a change from interactive Rule editing to executing the ValidateSyntax method.

Private Sub object_ModeChanged([Mode As String])

The event syntax has these parts:

| Part | Description |
|---|---|
| object | An object expression that evaluates to a FactPool- |
| | Result control. |
| Mode | A string that determines mode in progress. |

Remarks:

The Mode string will contain one of the following settings:

| Constant | Value/Description |
|---|---|
| fpViewing | 0-Contents of the FactPool-Result control are being |
| | viewed. |
| fpEditing | 1-Contents of the FactPool-Result control are being |
| | edited. |
| fpValidating | 2-Contents of the FactPool-Result control are being |
| | validated. |
| fpEvaluating | 3-Contents of the FactPool-Result control are being |
| | evaluated. |

ProgressChanged Event

Occurs during processing of the ValidateSyntax and Evaluate methods at processing milestones.

Private Sub object_ProgressChanged([Activity As String], [PercentComplete As Integer])

The event syntax has these parts:

| Part | Description |
|---|---|
| object | An object expression that evaluates to a FactPool- |
| | Result control. |
| Activity | A string that determines an activity in progress. |
| PercentComplete | An integer that quantifies the progress currently |
| | achieved. |

Remarks:

The Activity string contains either “Validating” for the ValidateSyntax method, or “Evaluating” for the Evaluate method. This event can be used to drive a progress bar in the host program interface.

ReConfigured Event

Occurs when a FactPool—Result control's internal windows get resized, or when the Visible property is changed.

Private Sub objec_ReConfigured( )

The event syntax has these parts:

| Part | Description |
|---|---|
| object | An object expression that evaluates to a FactPool- |
| | Result control. |

Remarks:

Internal window resizing occurs when:

one of the splitter bars is dragged

the Splitter1Top or Splitter2Top properties are changed

the Splitter1Dock or Splitter2Dock properties are changed.

RuleChanged Event

Occurs after Rule editing is ended.

Private Sub object_RuleChanged( )

The event syntax has these parts:

| Part | Description |
|---|---|
| object | An object expression that evaluates to a FactPool- |
| | Result control. |

Remarks:

When this event occurs the ValidRule property is set to ‘False’, and the ValidateSyntax method must be executed before the Rule can be used. For example the Evaluate and SaveRuleFile methods will raise an Error event.

Validated Event

Occurs when the ValidateSyntax method has completed.

Private Sub object_Validated( )

The event syntax has these parts:

| Part | Description |
|---|---|
| object | An object expression that evaluates to a FactPool - |
| | Result control. |

Remarks:

When this event occurs it notifies the host program that the ValidRule property has been set. The event simply confirms that validation has completed successfully, not the outcome. The ValidRule property value can still be True or False.

Methods

Evaluate Method

Parses the evaluation expression created from the rule by the Validate method, and applies Fact values to reach a conclusion. Then it makes the appropriate result assignments according to the rule's then clause.

object.Evaluate

The method syntax has these parts:

| Part | Description |
|---|---|
| object | An object expression that evaluates to a FactPool- |
| | Result control. |

Remarks:

This method ignores a rule when the ValidRule property is False.

LoadRuleFile Method

Loads a rule file from a .rtf file using the pathname/filename string in the RuleFile property.

object.LoadRuleFile

The method syntax has these parts:

| Part | Description |
|---|---|
| object | An object expression that evaluates to a FactPool- |
| | Result control. |

Remarks:

Once the rule file is loaded it is automatically validated by the ValidateSyntax method.

This method returns True if the file is found and successfully loaded.

Reset Method

Resets all properties of a FactPool—Result control to their defaults.

object.Reset

The method syntax has these parts:

| Part | Description |
|---|---|
| object | An object expression that evaluates to a FactPool - |
| | Result control. |

Remarks:

This method does not reset the Result property if the Cumulative property is True.

SaveRuleFile Method

Saves a rule as a .rtf file using the pathname/filename string in the RuleFile property.

object.SaveRuleFile

The method syntax has these parts:

| Part | Description |
|---|---|
| object | An object expression that evaluates to a FactPool - |
| | Result control. |

Remarks:

Once the rule file is loaded it is automatically validated by the ValidateSyntax method.

This method returns True if the file is saved successfully.

ValidateSyntax Method

Parses the rule to check that it conforms to the requirements of the SyntaxType property.

object.ValidateSyntax

The method syntax has these parts:

| Part | Description |
|---|---|
| object | An object expression that evaluates to a FactPool - |
| | Result control. |

Remarks:

This method changes the ValidRule property to True if the rule is valid, or False otherwise.

Properties

AllowUserEdit Property

Returns or sets the edit behaviour for the control.

object.AllowUserEdit [=boolean]

The property syntax has these parts:

| Part | Description |
|---|---|
| object | An object expression that evaluates to a FactPool |
| | control. |
| boolean | A boolean expression that determines if fpEdit Mode is |
| | allowed, as described in Settings. |

Settings:

The property settings are:

| Setting | Description |
|---|---|
| True | The control can be edited by right-clicking and selecting |
| | Edit at design-time, or by clicking at run-time. Default. |
| False | The control cannot be edited. |

Remarks:

Editing is achieved by clicking in the Rule, Facts or Operators windows, and by typing in the Result window.

At design-time all Facts that are entered in the rule text will be automatically extracted and placed in the Facts property and window. Then default values can be added.

Cumulative Property

Returns or sets the behaviour of the Result window for the FactPool—Result control.

object.Cumulative [=boolean]

The property syntax has these parts:

| Part | Description |
|---|---|
| object | An object expression that evaluates to a FactPool - |
| | Result control. |
| boolean | A boolean expression that determines if the Result |
| | window is cleared of previous results before a new |
| | result is posted. |

Settings:

The property settings are:

| Setting | Description |
|---|---|
| True | The Result window will be cleared each time prior to a |
| | new result being posted. Default. |
| False | The Result window will add each new result to the |
| | previous contents of the Result window. |

Remarks:

At run time the Reset method does not clear the Result window if the Cumulative property is True.

Facts Property

Returns or sets the Facts array of a control. Run time only.

object.Facts [=variant]

The property syntax has these parts:

| Part | Description |
|---|---|
| object | An object expression that evaluates to a FactPool control. |
| variant | A variant containing a two-dimensional variant array |
| | that contains pairs of Facts and Fact values (see |
| | remarks below). |

Remarks:

The array definition should be as follows:

Dim HostFacts( ) As Variant

Dim Count As Integer

ReDim HostFacts(2, Count)

Where HostFacts(1, Count) is the Fact name, HostFacts(2, Count) is the Fact value, and Count is the Fact number.

Mode Property

Returns the functional mode for a FactPoo—Result control. A read-only run time property.

object.Mode

The property syntax has these parts:

| Part | Description |
|---|---|
| object | An object expression that evaluates to a FactPool - |
| | Result control. |

Settings:

The property settings are:

| Constant | Value/Description |
|---|---|
| fpViewing | 0 - Contents of the FactPool - Result control are being |
| | viewed. |
| fpEditing | 1 - Contents of the FactPool - Result control are being |
| | edited. |
| fpValidating | 2 - Contents of the FactPool - Result control are being |
| | validated. |
| fpEvaluating | 3 - Contents of the FactPool - Result control are being |
| | evaluated. |

Remarks:

This property returns a value or constant expression, as shown in Settings above, that determines the functional mode currently active.

Result Property

Returns the result of a FactPool—Result control. This is displayed in the Result window of the control. It is assigned after the rule has been validated, and after the Facts property has been passed context values, and then the rule has been evaluated. A read-only run time property.

object.Result

The property syntax has these parts:

| Part | Description |
|---|---|
| object | An object expression that evaluates to a FactPool - |
| | Result control. |

Remarks:

This property returns a string containing a textual narrative communicating some consequence or recommendation arising from the rule evaluation. It can accumulate successive evaluation results if the Cumulative property is set to True. It is distinct from the rule's True or False outcome (as returned by the Evaluate method) or its ResultValue property.

ResultValue Property

Returns the result value of a FactPool—Result control. This is not displayed. It is assigned after the rule has been validated, and after the Facts property has been passed context values, and then the rule has been evaluated. A read-only run time property.

object.ResultValue

The property syntax has these parts:

| Part | Description |
|---|---|
| object | An object expression that evaluates to a FactPool - |
| | Result control. |

Remarks:

This property returns a variant containing some value arising from the rule evaluation. It is optional, and gets assigned a value in a rule's then clause when required. The Demo 2: Feedback program and sample code shows how it is used. It is the “value” of the result, as distinct from the rule's True or False outcome (as returned by the Evaluate method) or its Result property narrative. Other result values can be also assigned to Facts using the then rule clause, but this ResultValue property is the main “value” of rule evaluation, and is a built-in fact not shown in the Facts window.

RuleFile Property

Returns or sets the file path and name of a .rtf (Rich Text Format) file containing a valid rule string.

object.RuleFile [=string]

The property syntax has these parts:

| Part | Description |
|---|---|
| object | An object expression that evaluates to a FactPool |
| | control. |
| string | A string expression that contains a valid path and |
| | filename. |

Remarks:

This must be a valid path and .rtf filename. It should ideally be a file previously created using the SaveRuleFile method.

RuleRTFText Property

Returns or sets the RTF (Rich Text Format) string containing a FactPool rule to be displayed in the Rule window of a FactPool—Result control.

object.RuleRTFText [=string]

The property syntax has these parts:

| Part | Description |
|---|---|
| object | An object expression that evaluates to a FactPool |
| | control. |
| string | A string expression that contains a FactPool rule RTF |
| | string. |

Remarks:

The validity of the rule embedded in this RTF string depends on the SyntaxType property.

This property can be used by the host program to paste a rule string into a memo field of a record in a context table/file, or to read such a memo field and assign its contents to RuleRTFText. See the “Demo 3: Rules Edit” program and sample code.

Splitter1Dock Property

Returns or sets whether the Splitter 1 splitter bar is docked.

object.Splitter1Dock [=boolean]

The property syntax has these parts:

| Part | Description |
|---|---|
| object | An object expression that evaluates to a FactPool - |
| | Result control. |
| boolean | A boolean expression that specifies whether Splitter1 is |
| | docked (see remarks below). |

Settings:

The property settings are:

| Setting | Description |
|---|---|
| True | Docks Splitter1. Default. |
| False | Returns Splitter1 to its default position. |

Remarks:

Docking for Splitter1 is to move to a position immediately above Splitter2, thereby further opening the Result window and fully closing the Rule window. Splitter1 can still be subsequently moved by dragging and dropping it as usual. It will only be locked in place if the Splitter1Lock property is set to True.

Splitter1Lock Property

Returns or sets whether the Splitter1 splitter bar is locked.

object.Splitter1Lock [=boolean]

The property syntax has these parts:

| Part | Description |
|---|---|
| object | An object expression that evaluates to a FactPool - |
| | Result control. |
| boolean | A boolean expression that specifies whether Splitter1 is |
| | locked (see remarks below). |

Settings:

The property settings are:

| Setting | Description |
|---|---|
| True | Locks Splitter1. Default. |
| False | Unlocks Splitter1. |

Remarks:

Locking Splitter1 makes it stop responding to Clicking and Drag-and-Drop events.

Splitter1Top Property

Returns or sets the position of the top of Splitter1 splitter bar.

object.Splitter1Top [=value]

The property syntax has these parts:

| Part | Description |
|---|---|
| object | An object expression that evaluates to a FactPool - |
| | Result control. |
| value | A numeric expression that specifies the top of Splitter1 |
| | (see remarks below). |

Remarks:

The top of Splitterl is always given in Twips.

Splitter2 Dock

Returns or sets whether the Splitter2 splitter bar is docked.

object.Splitter2Dock [=boolean]

The property syntax has these parts:

| Part | Description |
|---|---|
| object | An object expression that evaluates to a FactPool - |
| | Result control. |
| boolean | A boolean expression that specifies whether Splitter2 is |
| | docked (see remarks below). |

Settings:

The property settings are:

| Setting | Description |
|---|---|
| True | Docks Splitter2. Default. |
| False | Returns Splitter2 to its default position. |

Remarks:

Docking for Splitter2 is to move to the bottom of the FactPool—Result control, thereby fully closing the Facts or Operators window. If Splitter1 is docked then this will further open the Result window, otherwise it will further open the Rule window.

Splitter2 can still be subsequently moved by dragging and dropping it as usual. It will only be locked in place if the Splitter2Lock property is set to True.

Splitter2Lock

Returns or sets whether the Splitter2 splitter bar is locked.

object.Splitter2Lock [=boolean]

The property syntax has these parts:

| Part | Description |
|---|---|
| object | An object expression that evaluates to a FactPool - |
| | Result control. |
| boolean | A boolean expression that specifies whether Splitter2 is |
| | locked (see remarks below). |

Settings:

The property settings are:

| Setting | Description |
|---|---|
| True | Locks Splitter2. Default. |
| False | Unlocks Splitter2. |

Remarks:

Locking Splitter2 makes it stop responding to Clicking and Drag-and-Drop events.

Splitter2Top Property

Returns or sets the position of the top of Splitter2 splitter bar.

object.Splitter2Top [=value]

The property syntax has these parts:

| Part | Description |
|---|---|
| object | An object expression that evaluates to a FactPool - |
| | Result control. |
| value | A numeric expression that specifies the top of Splitter2 |
| | (see remarks below). |

Remarks:

The top of Splitter2 is always given in Twips.

SyntaxType Property

Returns or sets the syntax used to validate a rule. Design time only.

object.SyntaxType [=value]

The property syntax has these parts:

| Part | Description |
|---|---|
| object | An object expression that evaluates to a FactPool control. |
| value | A value or constant expression that identifies the syntax |
| | to be used. |

Settings:

The property settings are:

| Constant | Value/Description |
|---|---|
| fpCommercial | 0 - A simple commercial syntax without nested “If”s, etc. |

Remarks:

This version of FactPool controls only recognizes one basic syntax designed for use by non-programmer end-users.

ValidRule

Returns or sets whether a control contains a rule which follows the syntax of the SyntaxType property. A read-only run time property.

object.ValidRule [=boolean]

The property syntax has these parts:

| Part | Description |
|---|---|
| object | An object expression that evaluates to a FactPool control. |
| boolean | A boolean expression that specifies whether the current |
| | rule is valid. |

Settings:

The property settings are:

| Setting | Description |
|---|---|
| True | A correct syntax current rule. |
| False | An incorrect syntax current rule. Default. |

Remarks:

If ValidRule is False then the Evaluate method will ignore the rule.

What I claim as my invention is:

1. A method of editing, viewing, checking and evaluating textual procedural rules during run-time of a compiled host program in such a way that supplements or modifies the inherent procedural logic of that host program, comprising:
a. providing a means of processing procedural rules in the form of text that can be incorporated or embedded in a host program as a software component,
b. providing a computer-readable medium having stored thereon the said software component,
c. providing a computer-readable medium having stored thereon the said host program,
d. providing a computer-readable medium having stored thereon a program for embedding said software component in said host program,
e. providing a computer processor for processing said program for embedding said software component in said host program,
f. providing said computer processor for processing said host program embedded with said software component,
g. providing a display which is operatively connected to said computer processor for displaying the graphical user interface of said plurality of programs and said software component,
h. providing a character input means which a human operator can use to input text in said computer processor,
i. providing a pointer means which said operator can manipulate to point to any location in the graphical user interface of said plurality of programs and said software component,
whereby said display with said character input means and said pointer means will be used to embed said software component in said host program using said program for embedding said software component in said host program, and
whereby said computer processor for processing said host program embedded with said software component will process procedural rules provided to said software component by said host program or by said character input means or said pointer,
whereby said display can display said rules represented by text which specify conditions for processing alternative sets of instructions, and
whereby said rules can alternatively be provided by the host program in the form of a textual string which specifies said conditions, and
whereby said rules also specify said alternative sets of instructions, and
whereby said host-program is enabled to recognize, evaluate, select and perform the said rules to achieve a desired effect, and
whereby said rules can be modified by end-users of said host-program as often and whenever required during run-time of said host-program to achieve some new desired effect, and
whereby the said rules text can be replaced or modified by said host-program as often and whenever required during run-time of the said host-program to achieve some new desired effect.

2. A machine for editing, viewing, checking and evaluating textual procedural rules during run-time of a compiled host program in a computer processor in such a way that supplements or modifies the inherent procedural rules of that host program, comprising:
a. a means of processing procedural rules in the form of text that can be incorporated or embedded in a host program as a software component,
b. a computer-readable medium having stored thereon the said software component,
c. a computer-readable medium having stored thereon the said host program,
d. a computer-readable medium having stored thereon a program for embedding said software component in said host program,
e. a computer processor for processing said program for embedding said software component in said host program,
f. said computer processor for processing said host program embedded with said software component,
g. a display which is operatively connected to said computer processor for displaying the graphical user interface of said plurality of programs and said software component,
h. a character input means which a human operator can use to input text in said computer processor,
i. a pointer means which said operator can manipulate to point to any location in the graphical user interface of said plurality of programs and said software component,
whereby said display with said character input means and said pointer means will be used to embed said software component in said host program using said program for embedding said software component in said host program, and
whereby said computer processor for processing said host program embedded with said software component will process procedural rules provided to said software component by said host program or by said character input means or said pointer,
whereby said display can display said rules represented by text which specify conditions for processing alternative sets of instructions, and
whereby said rules can alternatively be provided by the host program in the form of a textual string which specifies said conditions, and
whereby said rules also specify said alternative sets of instructions, and
whereby said host-program is enabled to recognize, evaluate, select and perform the said rules to achieve a desired effect, and
whereby said rules can be modified by end-users of said host-program as often and whenever required during run-time of said host-program to achieve some new desired effect, and
whereby the said rules text can be replaced or modified by said host-program as often and whenever required during run-time of the said host-program to achieve some new desired effect.
